(19) United States
(12) Patent Application Publication
(10) Pub. No.: US 2008/0277890 A1
(43) Pub. Date: Nov. 13, 2008

(54) Four-Way Forklift With Outwardly Pivoting Wheel Arms

(76) Inventors: Roger D. Boster, II, Blacklick, OH (US); Danny Lee Denney, Stoutsville, OH (US)

Correspondence Address: REINHART BOERNER VAN DEUREN P.C., 2215 PERRYGREEN WAY, ROCKFORD, IL, 61107, US

(21) Appl. No.: 12/114,009

(22) Filed: May 2, 2008

Related U.S. Application Data
(60) Provisional application No. 60/916,526, filed on May 7, 2007.

(51) Int. Cl. B66F 9/06; B62D 61/06

(52) U.S. Cl. 280/62; 187/222

(57) ABSTRACT

An apparatus and method are provided for improving stability in a lifting vehicle, such as a fork-lift, by operatively attaching one or more wheels of the vehicle to a chassis of the vehicle in such a manner that a steering axis of the wheel may be selectively moved between a narrow track orientation thereof and a wide track orientation thereof, while the wheel remains in rolling contact with a surface supporting the lifting vehicle.

### CROSS-REFERENCE TO RELATED PATENT APPLICATIONS

This patent application claims the benefit of U.S. Provisional Patent Application No. 60/916,526, filed May 7, 2007, the disclosure and teachings of which are incorporated herein in their entireties, by reference.

### FIELD OF THE INVENTION

This invention generally relates to lifting vehicles, such as fork-lifts and the like, and more particularly to four-way lifting vehicles which are capable of traversing movement from side-to-side, as well as in forward and reverse directions.

### BACKGROUND OF THE INVENTION

It is known to be advantageous to configure a lifting vehicle, such as a fork-lift, to include three or more wheels adapted for rolling motion on a surface, as the lifting vehicle travels over the surface in oppositely oriented forward and reverse directions, and right and left oppositely oriented traversing directions extending substantially perpendicular to the forward and reverse directions. Such an arrangement significantly enhances the maneuverability and versatility of the lifting vehicle during operation. A vehicle having the capability of traversing straight sideways, in addition to moving straight forward and back, eliminates a substantial amount of turning and maneuvering and allows use of the vehicle for lifting and moving loads in spaces which would otherwise be too confining to allow such operations.

In one common application of such a four-way lifting vehicle, a fork-lift, having a pair of right and left steerable front wheels disposed on opposite sides of a pair of forwardly extending lift forks, and one or more steerable rear wheels, is configured in such a manner that the front and rear wheels may be alternatively positioned, in coordination with each other, to provide for substantially fore and aft movement, or alternatively cooperatively positioned in a second orientation for traversing, side-to-side motion of the fork-lift. With such an arrangement, for example, the fork-lift may be driven toward the side of a flatbed trailer to insert the forks under a load resting on the trailer. The load may then be raised free of the trailer bed by the forks, and the fork-lift backed-up only a short distance, before the wheels are rotated for traversing motion, so that the fork-lift can move directly sideways along the side of the trailer, toward the rear end of the trailer. Once the fork-lift is moved in a transverse direction beyond the rear end of the trailer, for example, the wheels may then be rotated back to their standard orientation for fore and aft travel, and the load may be transferred and placed in another location through traditional fore and aft motion of the fork-lift.

In the past, a number of approaches have been taken, to provide such vehicles as evidenced by U.S. Published Patent Application 2005/0061570 A1, to McVicar et al., titled “Four-Directional Forklift Truck”; U.S. Published Patent Application 2004/0007415 A1, to Kouyama, titled “Working Vehicle With Traversed Travel System”; U.S. Pat. No. 6,913,102 B2, to Sugata et al., titled “Working Vehicle With Traversing System”; U.S. Pat. No. 6,854,552 B2, to Yurushi, titled “Forklift With Traverse Motion System”; U.S. Pat. No. 6,866,113 B2, to Sugata, titled “Forklift With Transverse Travel System”; U.S. Pat. No. 6,793,036 B1, to Enmeiji et al., titled “Working Vehicle With Transverse System”; U.S. Pat. No. 6,732,831 B2 to Enmeiji et al., titled “Fork Lift With Laterally Travelling System”; and U.S. Pat. No. 6,557,658 B1 to Enmeiji et al., titled Forklift Having Transverse Travel System.” Although these, and many other prior approaches, have had significant success in the marketplace for four-way fork-lift-type vehicles, it is commonly known in the marketplace that existing vehicles are less stable than is desirable, when moving in the traversing direction, particularly when supporting a load in an elevated position. It is desirable, therefore, to provide an apparatus and method for improving the stability of four-way lifting vehicles, particularly when they are operating in a traversing mode, but also in a more typical fore and aft direction as well.

It is further desirable that such an improved apparatus and method be applicable to four-way fork-lift-type vehicles in applications where the fork-lift is transported by using the lifting forks to engage the rear end of the bed of an over-the-road truck or trailer, in such a manner that the fork-lift-type vehicle can lift itself to a stowed position, at the rear of the trailer, for example, for transport with the truck bed or trailer. For such applications, government rules and regulations typically stipulate a maximum allowable width, which must be met by the truck and/or trailer with the fork-lift attached to the rear end thereof, during operation of the truck and/or trailer along a public roadway. Such regulations have, in the past, resulted in certain compromises being made in the design of four-way fork-lifts that are to be transported while attached to the rear end of an over-the-road truck and/or trailer. Such compromises have included using tires on the fork-lift which are narrower, or smaller in diameter, than would otherwise be desirable to provide enhanced operational stability to the fork-lift. Stated another way, the spacing between the wheels across the transverse width of the truck bed or trailer is limited by applicable government regulations, to such an extent that, in order to provide the widest spacing possible, between the transversely-spaced wheels, within applicable regulations, the tire tread width and/or diameter is reduced.

It is desirable, therefore, to provide an improved lifting vehicle having greater operational stability than prior vehicles, while operating particularly in a traversing direction. It is also desirable that such an improved vehicle provide improved stability during traditional forward and reverse operation, as well. It is further desirable to provide an apparatus and method for improving the stability of a four-way lifting vehicle.

### BRIEF SUMMARY OF THE INVENTION

The invention provides improved stability in a lifting vehicle by operatively attaching at least one wheel of the vehicle to the chassis of the vehicle in such a manner that a steering axis of the wheel may be selectively moved between a narrow track orientation thereof, and a wide track orientation thereof, while the wheel remains in rolling contact with a surface supporting the lifting vehicle.

In one form of the invention, a lifting vehicle, adapted for lifting a load, includes three or more steerable wheels, with the wheels being operatively attached to a chassis of the vehicle about respective steering axes of the wheels, and adapted for rolling motion on a surface as the vehicle travels over the surface in oppositely oriented forward and reverse directions, and in right and left oppositely oriented traversing directions extending substantially perpendicular to the forward and reverse directions. The lifting vehicle includes a wheel steering axis positioning apparatus, operatively attaching at least one of the wheels to the chassis and configured for selectively moving the steering axis of the at least one of the wheels between a narrow track orientation thereof, and a wide track orientation thereof, while the at least one wheel remains in rolling contact with the surface.

A wheel steering axis positioning apparatus, according to the invention, may be configured for turning the at least one of the wheels about its steering axis to an orientation of the wheel, whereat that wheel will roll across the surface as that wheel is moved between the narrow track and the wide track orientations thereof, to thereby maintain rolling contact of the wheel with the surface.

A vehicle, according to the invention, may be a fork-lift, adapted for attachment, stowage and transport on the aft end of a over-the-road truck, with the narrow track orientation being configured to provide an overall width meeting regulations for maximum width for over-the-road transport.

In some forms of the invention, the steerable wheels, of a vehicle according to the invention, are configured and operatively interconnected such that they can all be selectively oriented in a first relative position, with respect to one another, so that the vehicle may operate in a standard operational mode, in which the vehicle moves substantially in the forward and reverse directions. The steerable wheels may be further configured and cooperatively connected such that all of the wheels may be alternatively and selectively oriented in a second relative position, with respect to one another, so that the vehicle may operative in a traversing mode, in which the vehicle moves substantially in the right and left transverse directions.

The steerable wheels may include left and right front wheels, and at least one rear wheel, with the one rear wheel providing primary steering control in the standard operational mode, and the front wheels providing primary steering control in the traversing mode. The front wheels may be oriented for a rolling motion across the surface primarily in the forward and reverse directions, when the vehicle is operating in the standard mode, and the front wheels may be further oriented for rolling motion across the surface primarily in the transverse direction when the vehicle is operating in the traversing operational mode.

In some forms of the invention, the front and rear wheels can all be selectively oriented in a first relative position, with respect to one another, such that the vehicle may operate in the standard operational mode, wherein the vehicle moves substantially in the forward and reverse directions, and such that the front and rear wheels can alternatively be selectively oriented in the second relative position with respect to one another, such that the vehicle may operate in the transversing mode, to thereby allow the vehicle to move substantially in the right and left traversing directions. The vehicle may be further configured such that orientation of the front and rear wheels is cooperatively coordinated, prior to, after and during transitioning between the standard and traversing modes of operation.

In all forms of the invention, it will be understood that during either the standard or traversing modes of operation, one or more of the wheels of the vehicle may be turned from a substantially fore and aft or side-to-side orientation, to provide steering of the vehicle, and/or movement of the vehicle in a direction angled somewhat from straight fore and aft or side-to-side.

In one form of a lifting vehicle for lifting a load, according to the invention, the vehicle includes three or more wheels adapted for rolling motion on a surface, as the vehicle travels over the surface in oppositely oriented forward and reverse directions, and right and left oppositely oriented traversing directions extending substantially perpendicular to the forward and reverse directions of the vehicle. Such a vehicle may include a chassis, at least one steerable rear wheel, right and left steerable front wheels, and a front wheel steering axis positioning apparatus. The chassis defines a longitudinal fore and aft axis of the vehicle, extending between a front and a rear end of the vehicle, along the forward and reverse directions of travel of the vehicle. The chassis further defines a transverse side-to-side axis extending perpendicular to the longitudinal axis between a left and a right side of the vehicle, along the right and left traversing directions of travel of the vehicle.

The steerable rear wheel may be operatively attached to the chassis adjacent the rear end of the vehicle, in a manner allowing the rear wheel to be pivoted about a rear wheel steering axis which extends substantially orthogonally to the longitudinal and transverse axes. The right and left steerable front wheels may be operatively attached to the chassis, adjacent the front end of the vehicle, in a manner allowing the right and left front wheels to be selectively pivoted about respective right and left front wheel steering axes, with each of the front wheel steering axes extending substantially orthogonally to both the longitudinal and transverse axes.

The front wheel steering axis positioning apparatus may operatively connect the right and left front wheels to the chassis, on opposite right and left sides of the longitudinal axis. The front wheel steering axis positioning apparatus may be configured for selectively moving the front wheels between a narrow track orientation thereof and a wide track orientation thereof, while the front wheels remain in rolling contact with the surface. In the narrow track orientation, the right and left front wheels are transversely spaced at a first distance from one another, and in the wide track orientation, the right and left front wheels are transversely spaced at a second distance from one another, with the second distance being greater than the first distance.

The front wheel steering axis positioning apparatus, in some forms of the invention, is configured for turning the one of the front wheels about its steering axis to an orientation of that wheel whereat that wheel will roll across the surface as that wheel is moved between the narrow track and wide track orientations thereof, to thereby maintain rolling contact with the surface. By maintaining rolling contact with the surface, the wheel is not skidded sideways across the surface while changing between the narrow and wide track orientations.

In some forms of the invention, the vehicle may be a fork-lift, adapted for attachment, stowage and transport, on the aft end of an over-the-road truck, with the narrow track orientation being configured to provide an overall width meeting regulations for maximum width limitations of over-the-road transport.

In some forms of the invention, a vehicle, according to the invention, may include a lifting arrangement extending along the longitudinal axis and adapted for lifting the load in a direction substantially orthogonal to both the longitudinal and transverse axes. In other forms of a vehicle, according to the invention, the vehicle may alternatively include a lifting arrangement extending along the transverse axis and adapted for lifting the load in a direction substantially orthogonal to both the longitudinal and transverse axes.

In a vehicle, according to the invention, the front wheels and rear wheels can all be selectively oriented in a first relative position with respect to one another, such that the vehicle may operate in a standard operational mode in which the vehicle moves substantially in the forward and reverse directions, and also alternatively, selectively, oriented in a second relative position, with respect to one another, such that the vehicle may operate in a traversing mode, in which the vehicle moves substantially in the right and left traversing directions. In some forms of the invention, a front wheel steering axis positioning apparatus, according to the invention, may include a pivot arm arrangement having a pivotable arm operatively connecting one or more of the front wheels to the chassis for selective movement of the steering axis of the front wheel connected to the pivotable arm from a first to a second transverse position thereof, with respect to the longitudinal axis, through pivoting action of the pivotable arm. The pivotable arm may have a first end thereof pivotably attached to the chassis, for pivoting motion of the pivotable arm about a pivot point on the chassis, through an arc of movement including a first angular position of the pivotable arm, in which the pivotable arm extends substantially parallel to the longitudinal axis, and a second angular position of the pivotable arm, in which the pivotable arm extends at an angle to the longitudinal axis. The pivotable arm may further have a distal end thereof adapted for pivotable attachment thereto of the one of the front wheels, and defining the steering axis of that one of the front wheels.

The first angular position of the pivotable arm may place the steering axis of the one of the front wheels in the narrow track orientation thereof, and the second angular position of the pivotable arm may place the steering axis of the one of the front wheels in the wide track orientation thereof.

The front wheel steering axis positioning apparatus may further include a pivot arm actuator, operatively connected between the chassis and the pivotable arm, for selectively pivoting the pivotable arm about the pivot point on the chassis.

A front wheel steering axis positioning apparatus, according to the invention, may further include a controller for turning the one of the front wheels about its steering axis, to an orientation of the one of the wheels whereat that wheel will roll across the surface as the pivotable arm is pivoted about the pivot point on the chassis. In some forms of the invention, where the front and rear wheels can all be selectively oriented in a first and a second relative position with respect to one another, so that the vehicle may operate respectively in a standard operational mode or a traversing operational mode, the controller and vehicle may be further configured and operatively connected such that orientation of the front and rear wheels is cooperatively coordinated, prior to, after, and during transitioning between the standard and traversing modes of operation.

The invention may also take the form of a method for constructing and/or operating a lifting vehicle, in accordance with the invention.

In one form of a method for increasing the wheel spacing on a lifting vehicle adapted for lifting a load, in accordance with the invention, where the vehicle includes three or more steerable wheels operatively attached to a chassis of the vehicle about respective steering axes of the wheels and adapted for rolling motion on a surface in oppositely oriented forward and reverse directions and right and left oppositely oriented traversing directions extending substantially perpendicular to the forward and reverse directions, the method may include, operatively attaching at least one of the wheels to the chassis with a wheel positing steering axis apparatus configured for selectively moving the steering axis of the at least one of the wheels between a narrow track orientation thereof and a wide track orientation thereof, while the at least one wheel remains in rolling contact with the surface. The method may also include selectively moving the steering axis of the at least one of the wheels between the narrow track orientation thereof and the wide track orientation thereof, while the at least one wheel remains in rolling contact with the surface. The method may further include turning the one of the front wheels about its steering axis to an orientation of the one of the wheels whereat the one of the wheels will roll across the surface as that wheel is moved between the narrow track and the wide track orientations thereof. After a transition between the narrow and wide track orientations, a method, according to the invention, may yet further include turning one of the front wheels to an orientation consistent with operation substantially in the forward and reverse directions, or alternatively, turning the one of the front wheels to an orientation consistent with operation substantially in the right and left traversing directions.

Where a lifting vehicle includes a chassis defining a longitudinal fore and aft axis of the vehicle extending between a front and rear end of the vehicle along the forward and reverse directions of travel of the vehicle, and, a transverse side-to-side axis extending perpendicular to the longitudinal axis between a left and a right side of the vehicle along the right and left traversing directions of travel of the vehicle, a method, according to the invention, may include selectively moving the steering axis of at least one of the front wheels between a narrow track orientations thereof and a wide track orientation thereof, with respect to the longitudinal axis, while the at least one wheel remains in rolling contact with the surface.

Some forms of a method, according to the invention, may include operatively attaching at least one steerable rear wheel to the chassis adjacent the rear end of the vehicle in a manner allowing the rear end to be pivoted about a rear wheel steering axis extending substantially orthogonally to the longitudinal and transverse axes. A method, according to the invention, may also include operatively attaching right and left steerable front wheels to the chassis to the front wheel steering axis positioning apparatus, adjacent the front end of the vehicle and on opposite side of the longitudinal axis, in a manner allowing the right and left front wheels to be selectively and respectively pivoted by the front wheel steering axis positioning apparatus about right and left front wheel steering axes, each extending substantially orthogonally to the longitudinal and transverse axes. A method may further include selectively moving the front wheels between a narrow track orientation thereof and a wide track orientation thereof, while the front wheels remain in contact with the surface.

In forms of the invention having one or more steerable wheels attached to a chassis by pivotable arm, a method, according to the invention, may include moving the pivotable arm between a first and a second angular position thereof while transitioning from a substantially forward and reverse mode of operation to a traversing mode of operation.

Other aspects, objectives and advantages of the invention will be apparent from the following description and accompanying drawings of exemplary embodiment of the invention.

### BRIEF DESCRIPTION OF THE DRAWINGS

The accompanying drawings incorporated in and forming a part of the specification illustrate several aspects of the present invention and, together with the description, serve to explain the principles of the invention. To facilitate appreciation of the additional stability, and other advantages, provided through wide-track operation of a vehicle, according to the invention, all of the drawing figures, described below, show an exemplary embodiment of the fork-lift, substantially to the same scale. In the drawings:

FIG. 1 is a top view of an exemplary embodiment of a vehicle, according to the invention, in the form of a fork-lift, with FIG. 1 illustrating the fork-lift in a narrow-track configuration, for operation substantially in a forward and reverse direction.

FIG. 2 is a top view of the exemplary embodiment of the fork-lift of FIG. 1, with the fork-lift shown in a wide-track configuration, for traversing motion substantially along a transverse, left-to-right, axis.

FIGS. 3-5 are sequential top views of the fork-lift of FIGS. 1 and 2, illustrating a method and apparatus for transitioning the fork-lift from the narrow track, fore and aft, configuration shown in FIG. 1, to the wide track, traversing operational mode, shown in FIG. 2, in such a manner that the wheels of the fork-lift remain in rolling contact with a surface upon which the fork-lift is resting prior to, during, and subsequent to making the transition from the operating mode shown in FIG. 1 to the operating mode shown in FIG. 2.

FIG. 6 is a top view of the fork-lift of FIGS. 1 and 2, showing the fork-lift configured in a narrow-track mode, for substantially traversing operation.

FIG. 7 is a top view of the fork-lift of FIGS. 1 and 2, showing the fork-lift configured for wide-track operation, substantially in the forward and reverse direction of travel.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

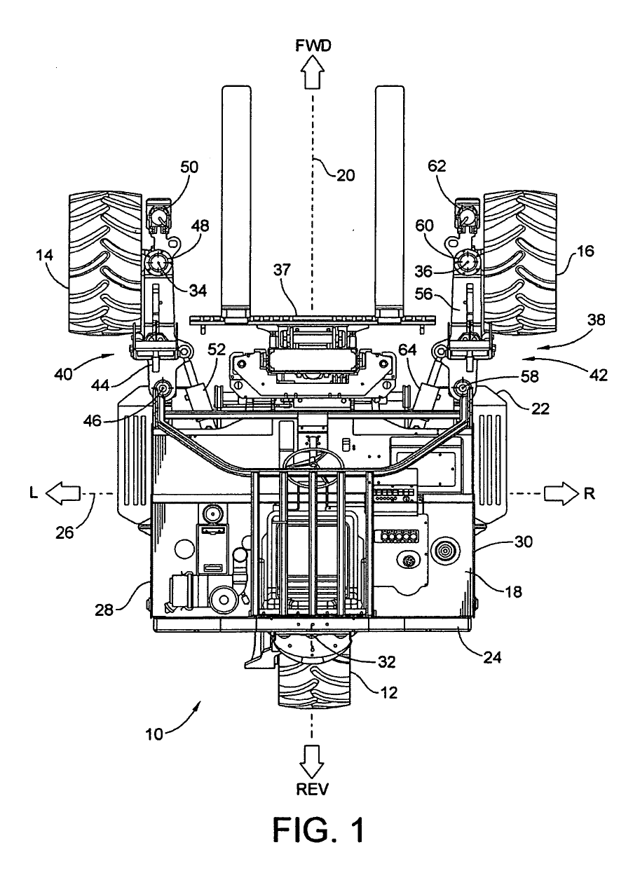

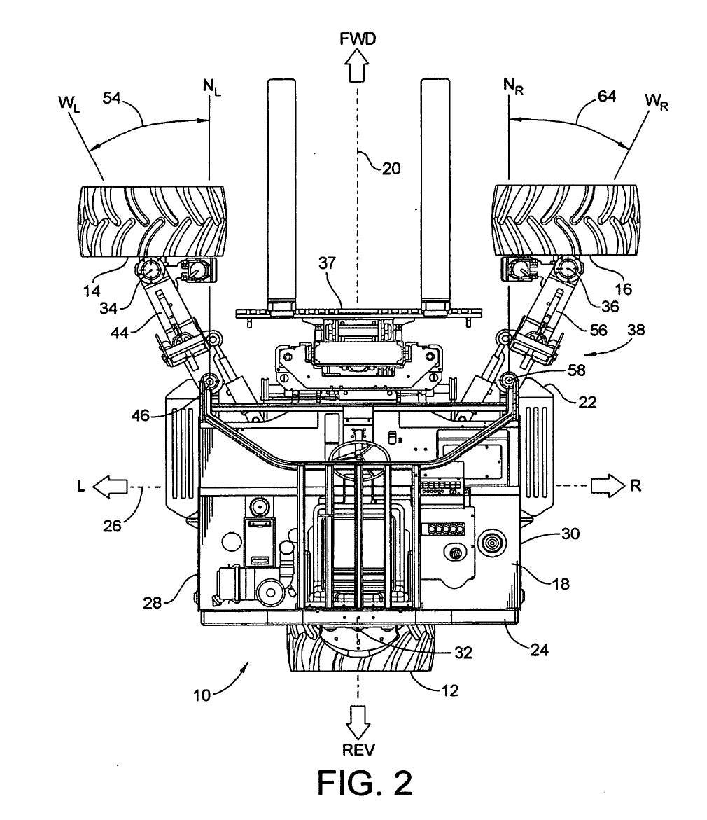

FIGS. 1 and 2 show a first exemplary embodiment of a lifting vehicle, in the form of a fork-lift 10, for lifting a load. The exemplary embodiment of the fork-lift 10 includes a steerable rear wheel 12, and left and right steerable front wheels 14, 16, adapted for rolling motion on a surface, as the fork-lift 10 travels over the surface in oppositely oriented forward and reverse directions FWD, REV, and right and left R, L oppositely oriented traversing directions extending substantially perpendicular to the forward and reverse directions.

The wheels 12, 14, 16, are operatively attached to a chassis 18, in a manner to be described in greater detail below. The chassis 18 defines a longitudinal fore and aft axis 20 of the fork-lift 10, extending between a front and a rear end 22, 24 of the fork-lift 10, along the forward and reverse FWD, REV directions of travel of the fork-lift 10. The chassis 18 further defines a transverse, side-to-side, axis 26, which extends perpendicular to the longitudinal axis 20, between a left and a right side 28, 30 of the fork-lift 10, along the left and right L, R traversing directions of travel of the fork-lift 10.

The steerable rear wheel 12 is operatively attached to the chassis 18, adjacent the rear end 24 of the fork-lift 10, in a manner allowing the rear wheel 12 to be pivoted about a rear wheel steering axis 32 extending substantially orthogonally to the longitudinal and transverse axes 20, 26. In similar fashion, the left and right steerable front wheels 14, 16 are each operatively attached to the chassis 18, in a manner described in more detail below, adjacent the front end 22 of the fork-lift 10, in a manner allowing the left and right front wheels 14, 16 to be selectively pivoted about respective left and right front wheel steering axes 34, 36, each extending substantially orthogonally to the longitudinal and transverse axes 20, 26.

The exemplary embodiment of the fork-lift 10 includes a lifting arrangement 37, having a pair of lifting forks, extending along the longitudinal axis 20, and adapted for lifting a load (not shown) in a direction substantially orthogonal to both the longitudinal and transverse axes 20, 26. Those having skill in the art will recognize that the exemplary embodiment of the fork-lift 10 is of the type known in the art as a four-way forklift having steerable (pivotable) wheels that can be pivoted 90 degrees, to allow the fork-lift 10 to move laterally. It will be further recognized, by those having skill in the art, that the exemplary embodiment of the fork-lift 10 is of a type adapted for attachment, stowage and transport on the aft end of an over-the-road truck. In such applications, the forks of the lifting apparatus 37 are raised to engage mating channels mounted to the underside of the truck bed. The lifting arrangement 37 is then utilized to raise the fork-lift 10 off of the ground and into a stowage position on the aft end of the truck, for transport with the truck.

The left and right front wheels 14, 16 are attached to the front end 22 of the fork-lift 10 by a front wheel steering axis positioning apparatus 38, which operatively connects the left and right front wheels 14, 16 to the chassis 18 on opposite left and right sides of the longitudinal axis 20. The front wheel steering axis positioning apparatus 38 is configured for selectively moving the front wheels 14, 16 between a narrow track orientation thereof, as illustrated in FIG. 1, for operating the fork-lift 10 in a standard, primarily fore and aft mode, and a wide track orientation thereof, as illustrated in FIG. 2, for operating the fork-lift 10 in a traversing, primarily side-to-side mode, while the front wheels 14, 16 remain in rolling contact with the surface.

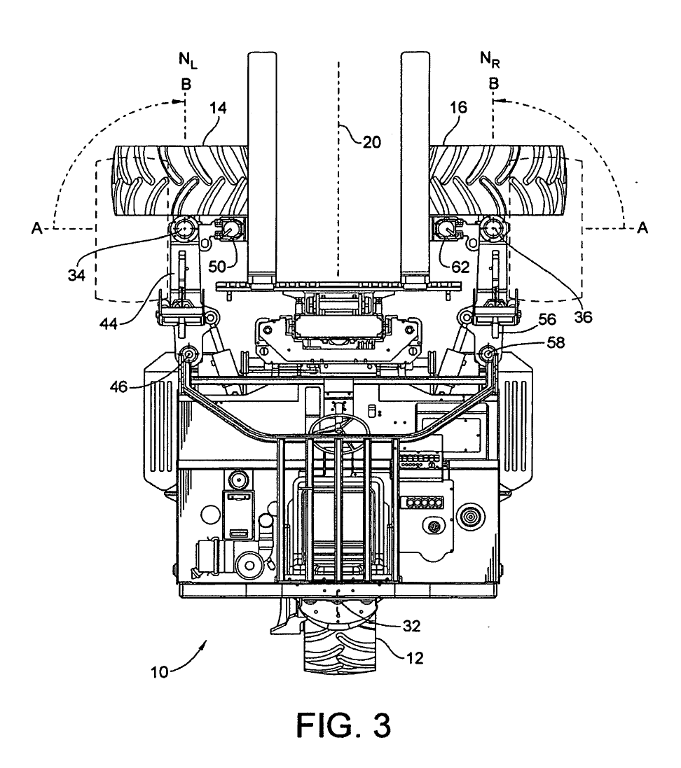

FIGS. 3-5 illustrate the manner in which the front wheel steering axis positioning apparatus 38, of the exemplary embodiment of the fork-lift 10, is constructed and operated to transition the fork-lift 10 from the standard operating mode, shown in FIG. 1, to the traversing operational mode shown in FIG. 2. It will be understood, however, that in other embodiments of the invention, a front wheel steering axis positioning apparatus, according to the invention, may be constructed and operated in a manner substantially different from the steering axis positioning apparatus 38, of the exemplary embodiment of the fork-lift 10, within the scope of the present invention. It will be further understood, however, that in the exemplary embodiment of the fork-lift 10, the method and sequence of pivoting of the wheels 12, 14, 16 may differ from the sequence described below, within the scope of the invention.

As shown in FIG. 1, the front wheel steering axis positioning apparatus 38, of the exemplary embodiment of the fork-lift 10, includes a pair of substantially mirror-imaged left and right pivot arm arrangements 40, 42 which respectively operatively connect the left and right front wheels 14, 16 to the front end 22 of the chassis 18 of the fork-lift 10. The left pivot arm arrangement 40 includes a left pivot arm 44 having an aft end thereof pivotably attached at a pivot point 46 of the left pivot arm 44 to the front end 22 of the chassis 18. A distal end 48, of the left pivot arm 44, defines the left front wheel steering axis 34, and is adapted for attachment thereto of a left front wheel drive and steering motor 50. The left pivot arm arrangement 40 also includes an actuator, in the form of a hydraulic cylinder 52, which is operatively connected between the chassis 18 and the left pivot arm 44, for moving the left pivot arm 44, about the pivot axis 46 of the left pivot arm 44, through an arc of movement 54, between a first, narrow track position N_{L} of the left pivot arm, in which the left pivot arm extends substantially parallel to the longitudinal axis 20, and a second, wide track angular position W_{L} of the left pivot arm 44, in which the left pivot arm extends at an angle to the longitudinal axis 20, as shown in FIG. 2.

In similar fashion, as shown in FIG. 2, the right pivot arm arrangement 42 includes a right pivot arm 56, having an aft end thereof attached to the chassis 18 at a pivot axis 58 of the right pivot arm 56, and a distal end 60 thereof, defining the right front wheel steering axis 36, with the distal end 60 also adapted for attachment thereto of a right wheel drive and steering motor 62.

As shown in FIGS. 1 and 2, the right pivot arm arrangement 42 also includes an actuator, in the form of a hydraulic cylinder 64, operatively attached between the chassis 18 and the right pivot arm 56, for pivoting the right pivot arm 56 about its pivot point 58 through an arc of movement 64 from a first, narrow track position N_{R}, in which the right pivot arm 56 extends substantially parallel to the longitudinal axis 20, to a second, wide track angular position W_{R} of the right pivot arm 56, in which the right pivot arm 56 extends at an angle to the longitudinal axis 20.

FIGS. 3-5 illustrate one possible sequence for transitioning from the standard mode to the traversing mode of operation, using the exemplary embodiment of the left and right front wheel steering axis positioning apparatus 38, described above, in such a manner that all of the wheels 12, 14, 16 of the fork-lift 10 remain in rolling contact with the surface at all times, prior to, during, and subsequent to transitioning between the narrow track standard operation mode shown in FIG. 1 and the wide track traversing mode of operation shown in FIG. 2.

As shown in FIG. 3, the left and right front wheels 14, 16 are first pivoted about their respective steering axes 34, 36 by their respective drive and steering motors 50, 62, from respective positions A, as shown by phantom lines in FIG. 3 to respective positions B, at which the front wheels 14, 16 are oriented substantially perpendicular to the longitudinal axis 20. During the repositioning of the front wheels 14, 16, with respect to the pivot arms 44, 56, the rear wheel 12 is oriented in substantially a straight, fore and aft position, as shown in FIG. 3, to provide stability as the left and right front wheels 14, 16 are pivoted in opposite directions, relative to one another, about their respective steering axes 34, 36.

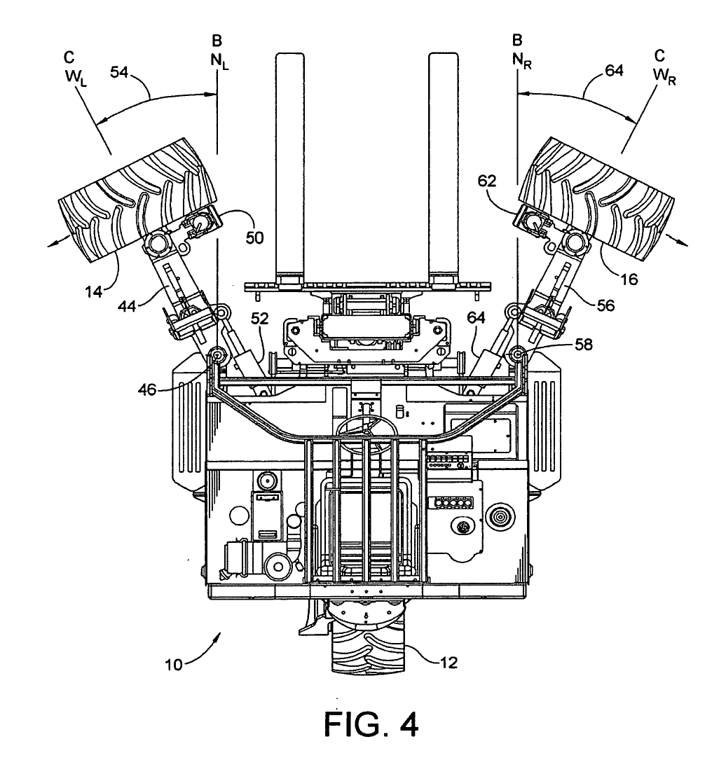

As shown in FIG. 4, the left and right pivot arms 44, 56 are then pivoted about their respective pivot points 46, 58 by their respective hydraulic cylinders 52, 64 through respective arcs of travel 54, 64, to move the front wheels 14, 16 from their respective positions B, as shown in FIG. 3, to the positions C shown in FIG. 4. By virtue of having first pivoted the left and right front wheels 14, 16 about their respective steering axes 34, 36 to the positions B shown in FIG. 3, the front wheels 14, 16 roll along the surface as the pivot arms 44, 56 are pivoted about their respective pivot points 46, 58 by the hydraulic cylinders 52, 64. In some forms of the invention, the steering and drive motors 50, 62 may also be utilized, in conjunctions with the hydraulic cylinders 52, 64, for moving the left and right front wheels from their respective positions B to their respective positions C. It will be further noted that, as shown in FIG. 4, the rear wheel 12 is left in its substantially fore-and-aft position, during the outward pivoting of the pivot arms 44, 56, to provide stability for the fork-lift 10.

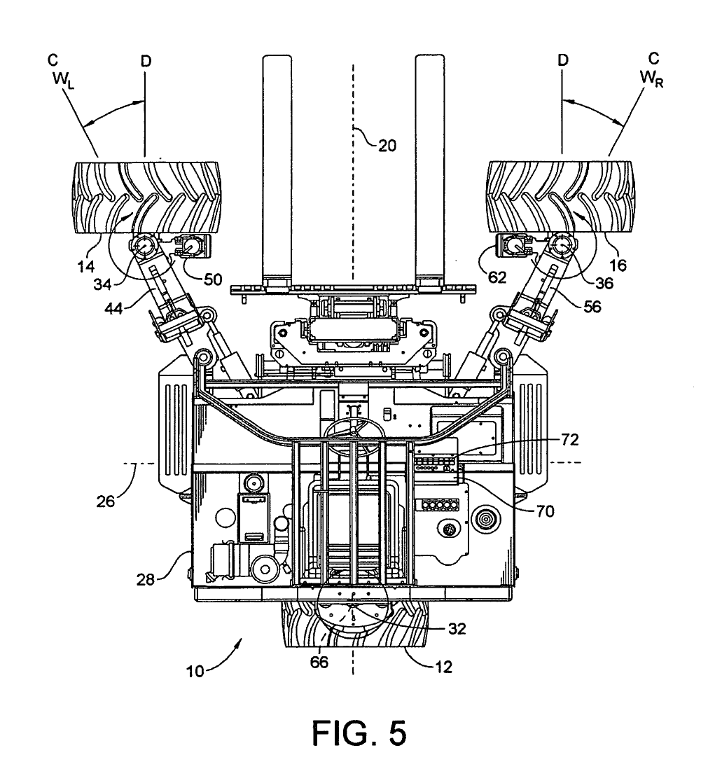

As shown in FIG. 5, once the left and right pivot arms 44, 56 are moved to their respective wide track positions W_{L}, W_{R}, the left and right drive and steering motors 50, 62 are energized to pivot the front wheels 14, 16, about their respective steering axes 34, 36, from the position C shown in FIG. 4, to position D, as shown in FIG. 5, whereat the left and right front wheels 14, 16 are oriented for rolling motion substantially along the transverse axis 26, and perpendicular to the longitudinal axis 20. The rear wheel 12 is then pivoted about its steering axis 32, by a rear wheel drive and steering motor 66, which is not specifically shown but is indicated by a dashed leader in FIG. 5, to a position whereat the rear wheel 12 is oriented for rolling motion substantially perpendicular to the longitudinal axis 20 and parallel to the transverse axis 26. In other embodiments of the fork-lift 10, it is contemplated that the rear wheel 12 may be pivoted prior to, or during movement of the front wheels 14, 16 from their respective positions C to their respective positions D.

As illustrated in FIG. 5, the exemplary embodiment of the fork-lift 10 includes a controller 70, which is operatively connected to the drive and steering motors 50, 62, 66, and to the hydraulic cylinders 52, 64, and configured to cooperatively coordinate the motion of the front and rear wheels 14, 16, 12, prior to, after, and during transitioning between the standard and traversing modes of operation. It is contemplated that the controller might include a push-button 72, for example, which when depressed by an operator of the fork-lift 10, would automatically transition the fork-lift 10, using the sequence of movements described above, between the narrow track, fore and aft mode, shown in FIG. 1, and the wide track, traversing operational mode, shown in FIG. 2.

It will be understood, however, by those having skill in the art that in other embodiments of the invention, structures and methods differing substantially from those laid out above with regard to the exemplary embodiment of the fork-lift 10, may also be used in practicing the invention. For example, in some embodiments of the invention, a front wheel steering axis positioning apparatus having a linear slide arrangement might be utilized instead of the pivot arm arrangements 40, 42 described with regard to the exemplary embodiment of the fork-lift 10. In some embodiments of the invention, it might be desirable to have only one of the wheels of the vehicle be moveable from a narrow track to a wide track position thereof. In some forms of the invention, it may be desirable to have two or more rear wheels. In other embodiments of the invention, it may be desirable to have a different form of lifting arrangement, or to have the vehicle configured such that the lifting arrangement is oriented in primarily a transverse direction, with the designations of longitudinal and transverse axes, as shown in the drawings, being understood strictly only to the exemplary embodiment of the fork-lift 10 described herein, for purposes of facilitating understanding of the invention.

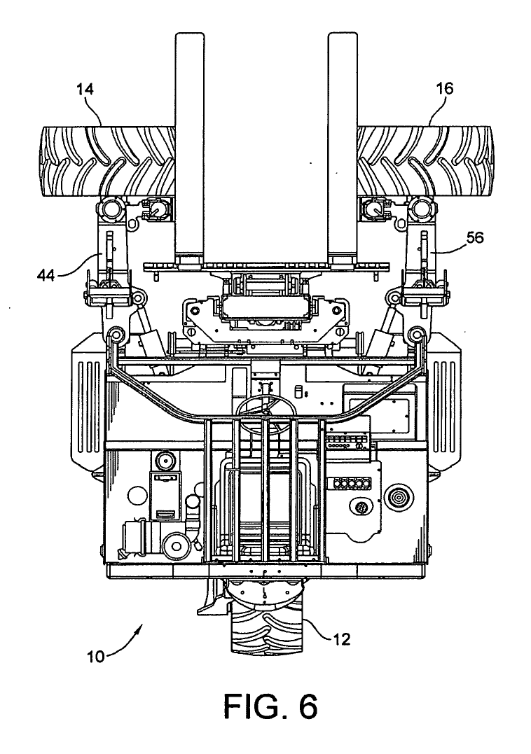

It will also be understood, by those having skill in the art, that the exemplary embodiment of the fork-lift 10 can be configured and operated in modes other than those strictly described above with regard to transitioning between the narrow track, substantially fore and aft, operating mode shown in FIG. 1, and the wide track, substantially side-to-side, traversing operating mode shown in FIG. 2. For example, as shown in FIG. 6, it is contemplated that the exemplary embodiment of the fork-lift 10 could also be operated in a narrow track traversing mode, as shown in FIG. 6, wherein the pivot arms 44, 56 are not pivoted outward. While the arrangement shown in FIG. 6 does not provide the widened wheel base, between the front wheels 14, 16 provided by the arrangement of FIG. 2, the narrow track orientation of FIG. 6 may provide sufficient stability and facilitate movement in tight quarters, or where only light loads are being lifted.

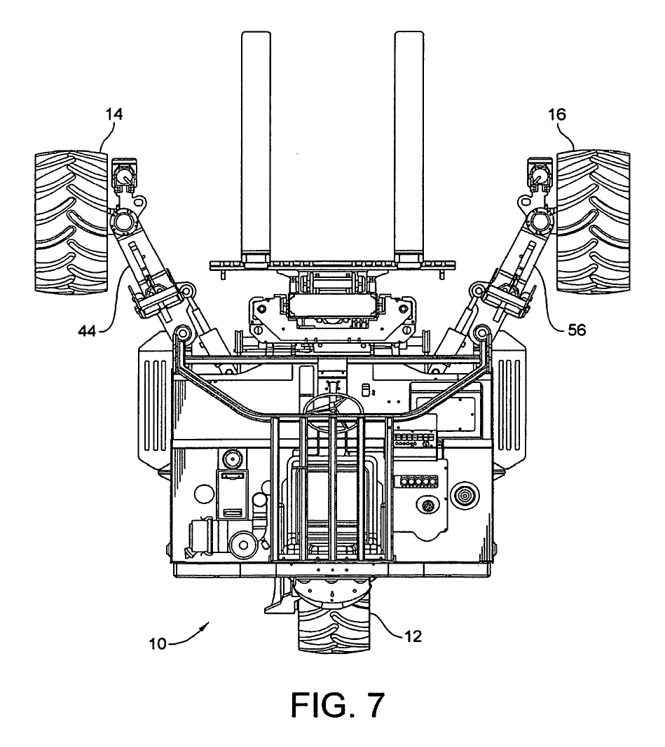

As shown in FIG. 7, it is contemplated that the exemplary embodiment of the fork-lift 10 might also be operated to advantage, in some circumstances with the pivot arms 44, 56 pivoted outward to their wide track position during substantially fore and aft movement of the fork-lift 10. Operation in this mode provides additional stability, through the wide track orientation of the front wheels 14, 16, in comparison to the arrangement shown in FIG. 1.

It will be further understood, that the invention may be practiced with an appropriate type of motor, i.e. hydraulic, electric, etc., or some combination thereof. In similar fashion, other types of actuators, such as ball screws, for example, powered by a variety of appropriate power sources, may be utilized for moving the wheels of a vehicle from a narrow track to a wide track position, in accordance with the invention.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventor for carrying out the invention. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A lifting vehicle adapted for lifting a load, where the vehicle includes three or more steerable wheels operatively attached to a chassis of the vehicle about respective steering axes of the wheels and adapted for rolling motion on a surface as the vehicle travels over the surface in oppositely oriented forward and reverse directions and right and left oppositely oriented traversing directions extending substantially perpendicular to the forward and reverse directions, the lifting vehicle comprising:
a wheel positioning steering axis apparatus operatively attaching at least one of the wheels to the chassis and configured for selectively moving the steering axis of the at least one of the wheels between a narrow track orientation thereof and a wide track orientation thereof, while the at least one wheel remains in rolling contact with the surface.

2. The vehicle of claim 1, wherein, the wheel steering axis positioning apparatus is configured for turning the at least one of the wheels about its steering axis to an orientation of the one of the wheels whereat the one of the wheels will roll across the surface as the one of the wheels is moved between the narrow track and wide track orientations thereof, to thereby maintain rolling contact with the surface.

3. The vehicle of claim 1, wherein, the vehicle is a fork-lift adapted for attachment stowage and transport on the aft end of an over-the-road truck, and the narrow track orientation is configured to provide and overall width meeting regulations for maximum width for over-the road transport.

4. The vehicle of claim 1, wherein:
the steerable wheels can all be selectively oriented in a first relative position with respect to one another such that the vehicle may operate in a standard operational mode in which the vehicle moves substantially in the forward and reverse directions; and
the steerable wheels can also all be alternatively selectively oriented in a second relative position with respect to one another such that the vehicle may operate in a traversing mode in which the vehicle moves substantially in the right and left traversing direction.

5. The vehicle of claim 4, wherein, the steerable wheels include left and right front wheels and at least one rear wheel, and the at least one rear wheel provides primary steering control in the standard operational mode, and the front wheels provide primary steering control in the traversing mode.

6. The vehicle of claim 5, wherein:
the front wheels are oriented for rolling motion across the surface primarily in the forward and reverse directions when the vehicle is operating in the standard operational mode; and
the front wheels are oriented for rolling motion across the surface primarily in the transverse direction when the vehicle is operating in the traversing operational mode.

7. The vehicle of claim 6, wherein;
the front and rear wheels can all be selectively oriented in a first relative position with respect to one another such that the vehicle may operate in the standard operational mode in which the vehicle moves substantially in the forward and reverse directions;
the front and rear wheels can alternatively be selectively oriented in the second relative position with respect to one another such that the vehicle may operate in a traversing mode in which the vehicle moves substantially in the right and left traversing direction; and
the vehicle is further configured such that orientation of the front and rear wheels is cooperatively coordinated, prior to, after, and during transitioning between the standard and traversing modes of operation.

8. A lifting vehicle for lifting a load, the vehicle having three or more wheels adapted for rolling motion on a surface as the vehicle travels over the surface in oppositely oriented forward and reverse directions and right and left oppositely oriented traversing directions extending substantially perpendicular to the forward and reverse directions, the lifting vehicle comprising:
a chassis defining a longitudinal fore and aft axis of the vehicle extending between a front and a rear end of the vehicle along the forward and reverse directions of travel of the vehicle, and a transverse side-to-side axis extending perpendicular to the longitudinal axis between a left and a right side of the vehicle along the left and right traversing directions of travel of the vehicle;
at least one steerable rear wheel operatively attached to the chassis adjacent the rear end of the vehicle in a manner allowing the rear wheel to be pivoted about a rear wheel steering axis extending substantially orthogonally to the longitudinal and transverse axes;
right and left steerable front wheels operatively attached to the chassis adjacent the front end of the vehicle in a manner allowing the right and left front wheels to be selectively pivoted about respective right and left front wheel steering axes each extending substantially orthogonally to the longitudinal and transverse axes; and
a front wheel steering axis positioning apparatus operatively connecting the right and left front wheels to the chassis on opposite right and left sides of the longitudinal axis;
the front wheel steering axis positioning apparatus being configured for selectively moving the front wheels between a narrow track orientation thereof and a wide track orientation thereof, while the front wheels remain in rolling contact with the surface, with the narrow track orientation having the right and left front wheels transversely spaced at a first distance from one another, and the wide track orientation having the right and left front wheels transversely spaced at a second distance from one another, with the second distance being greater than the first distance.

9. The vehicle of claim 8, wherein, the front wheel steering axis positioning apparatus is configured for turning the one of the front wheels about its steering axis to an orientation of the one of the wheels whereat the one of the wheels will roll across the surface as the one of the wheels is moved between the narrow track and wide track orientations thereof, to thereby maintain rolling contact with the surface.

10. The vehicle of claim 8, wherein, the vehicle is a fork-lift adapted for attachment, stowage and transport on the aft end of an over-the-road truck, and the narrow track orientation is configured to provide and overall width meeting regulations for maximum width for over-the road transport.

11. The vehicle of claim 8, further comprising a lifting arrangement extending along the longitudinal axis, and adapted for lifting the load in a direction substantially orthogonal to both the longitudinal and transverse axes.

12. The vehicle of claim 8, further comprising a lifting arrangement extending along the transverse axis, and adapted for lifting the load in a direction substantially orthogonal to both the longitudinal and transverse axes.

13. The vehicle of claim 8, wherein:
the front wheels and the rear wheel can all be selectively oriented in a first relative position with respect to one another such that the vehicle may operate in a standard operational mode in which the vehicle moves substantially in the forward and reverse directions; and
alternatively selectively oriented in a second relative position with respect to one another such that the vehicle may operate in a traversing mode in which the vehicle moves substantially in the right and left traversing direction.

14. The vehicle of claim 13, wherein, the rear wheel provides primary steering control in the standard operational mode, and the front wheels provide primary steering control in the traversing mode.

15. The vehicle of claim 13, wherein:
the front wheels are oriented for rolling motion across the surface primarily in the longitudinal direction when the vehicle is operating in the standard operational mode; and
the front wheels are oriented for rolling motion across the surface primarily in the transverse direction when the vehicle is operating in the traversing operational mode.

16. The vehicle of claim 8, wherein, the front wheel steering axis positioning apparatus comprises, a pivot arm arrangement having a pivotable arm operatively connecting one of the front wheels to the chassis by for selective movement of the steering axis of the one of the front wheels from a first to a second transverse position thereof, with respect to the longitudinal axis, through pivoting action of the pivotable arm.

17. The vehicle of claim 16, wherein:
the pivotable arm has a first end thereof pivotably attached to the chassis for pivoting motion of the pivotable arm about a pivot point on the chassis through an arc of movement including a first angular position of the pivotable arm in which the pivotable arm extends substantially parallel to the longitudinal axis, and a second angular position of the pivotable arm in which the pivotable arm extends at an angle to the longitudinal axis; and
the pivotable arm has a distal end thereof adapted for pivotable attachment thereto of the one of the front wheels and defining the steering axis of the one of the front wheels.

18. The vehicle of claim 17, wherein, the first angular position of the pivotable arm places the steering axis of the one of the front wheels in the narrow track orientation thereof, and the second angular position of the pivotable arm places the steering axis of the one of the front wheels in the wide track orientation thereof.

19. The vehicle of claim 17, wherein, the front wheel steering axis positioning apparatus further comprises, a pivot arm actuator operatively connected between the chassis and the pivotable arm for selectively pivoting the pivotable arm about the pivot point on the chassis.

20. The vehicle of claim 19, wherein, the front wheel steering axis positioning apparatus further comprises a controller for turning the one of the front wheels about its steering axis to an orientation of the one of the wheels whereat the one of the wheels will roll across the surface as the pivotable arm is pivoted about the pivot point on the chassis.

21. The vehicle of claim 20, wherein;
the front wheels and the rear wheel can all be selectively oriented in a first relative position with respect to one another such that the vehicle may operate in a standard operational mode in which the vehicle moves substantially in the forward and reverse directions;
the front and rear wheels can alternatively be selectively oriented in a second relative position with respect to one another such that the vehicle may operate in a traversing mode in which the vehicle moves substantially in the right and left traversing direction; and
the controller and vehicle are further configured and operatively connected such that orientation of the front and rear wheels is cooperatively coordinated, prior to, after, and during transitioning between the standard and traversing modes of operation.

22. A method for increasing the wheel spacing on a lifting vehicle adapted for lifting a load, where the vehicle includes three or more steerable wheels operatively attached to a chassis of the vehicle about respective steering axes of the wheels and adapted for rolling motion on a surface in oppositely oriented forward and reverse directions and right and left oppositely oriented traversing directions extending substantially perpendicular to the forward and reverse directions, the method comprising:
operatively attaching at least one of the wheels to the chassis with a wheel positioning steering axis apparatus configured for selectively moving the steering axis of the at least one of the wheels between a narrow track orientation thereof and a wide track orientation thereof, while the at least one wheel remains in rolling contact with the surface.

23. The method of claim 22, further comprising, selectively moving the steering axis of at least one of the wheels between a narrow track orientation thereof and a wide track orientation thereof, while the at least one wheel remains in rolling contact with the surface.

24. The method of claim 23, further comprising, turning the one of the front wheels about its steering axis to an orientation of the one of the wheels whereat the one of the wheels will roll across the surface as the one of the wheels is moved between the narrow track and wide track orientations thereof.

25. The method of claim 24, further comprising, after a transition between narrow and wide track orientation:
turning the one of the front wheels to an orientation consistent with operation substantially in the forward and reverse directions;
or alternatively, turning the one of the front wheels to an orientation consistent with operation substantially in the right and left traversing directions.

26. The method of claim 22, wherein, the vehicle comprises a chassis defining a longitudinal fore and aft axis of the vehicle extending between a front and a rear end of the vehicle along the forward and reverse directions of travel of the vehicle, and a transverse side-to-side axis extending perpendicular to the longitudinal axis between a left and a right side of the vehicle along the right and left traversing directions of travel of the vehicle, and the method further comprises: selectively moving the steering axis of at least one of the front wheels between a narrow track orientation thereof and a wide track orientation thereof, with respect to the longitudinal axis while the at least one wheel remains in rolling contact with the surface.

27. The method of claim 26, further comprising, selectively moving the steering axis of at least one of the wheels between a narrow track orientation thereof and a wide track orientation thereof, while the at least one wheel remains in rolling contact with the surface.

28. The method of claim 20, further comprising, turning the one of the front wheels about its steering axis to an orientation of the one of the wheels whereat the one of the wheels will roll across the surface as the one of the wheels is moved between the narrow track and wide track orientations thereof.

29. The method of claim 28, further comprising, after a transition between narrow and wide track orientation:
turning the one of the front wheels to an orientation consistent with operation substantially in the forward and reverse directions;
or alternatively, turning the one of the front wheels to an orientation consistent with operation substantially in the right and left traversing directions.

30. The method of claim 26, further comprising:
operatively attaching at least one steerable rear wheel to the chassis adjacent the rear end of the vehicle in a manner allowing the rear wheel to be pivoted about a rear wheel steering axis extending substantially orthogonally to the longitudinal and transverse axes;
operatively attaching right and left steerable front wheels to the chassis with the front wheel steering axis positioning apparatus, adjacent the front end of the vehicle and on opposite sides of the longitudinal axis, in a manner allowing the right and left front wheels to be selectively respectively pivoted by the front wheel steering axis positioning apparatus about right and left front wheel steering axes each extending substantially orthogonally to the longitudinal and transverse axes; and
selectively moving the front wheels between a narrow track orientation thereof and a wide track orientation thereof, while the front wheels remain in contact with the surface, with the narrow track orientation having the right and left front wheels transversely spaced at a first distance from one another, and the wide track orientation having the right and left front wheels transversely spaced at a second distance from one another, with the second distance being greater than the first distance.

31. The method of claim 30, wherein:
the front wheel steering axis positioning apparatus comprises, a pivot arm arrangement having a pivotable arm operatively connecting one of the front wheels to the chassis by for selective movement of the steering axis of the one of the front wheels from a first to a second transverse position thereof, with respect to the longitudinal axis, through pivoting action of the pivotable arm;
the pivotable arm has a first end thereof pivotably attached to the chassis for pivoting motion of the pivotable arm about a pivot point on the chassis through an arc of movement including a first angular position of the pivotable arm in which the pivotable arm extends substantially parallel to the longitudinal axis, and a second angular position of the pivotable arm in which the pivotable arm extends at an angle to the longitudinal axis;
the pivotable arm has a distal end thereof adapted for pivotable attachment thereto of the one of the front wheels and defining the steering axis of the one of the front wheels;
the first angular position of the pivotable arm places the steering axis of the one of the front wheels in the narrow track orientation thereof, and the second angular position of the pivotable arm places the steering axis of the one of the front wheels in the wide track orientation thereof; and
the method further comprises, moving the pivotable arm between the first and second angular positions thereof.

32. The method of claim 31, wherein, the front wheel steering axis positioning apparatus further comprises, a pivot arm actuator operatively connected between the chassis and the pivotable arm for selectively pivoting the pivotable arm about the pivot point on the chassis, and the method further comprises moving the pivotable arm with the pivot arm actuator.

33. The method of claim 32, further comprising, turning the one of the front wheels about its steering axis to an orientation of the one of the wheels whereat the one of the wheels will roll across the surface as the pivotable arm is pivoted about the pivot point on the chassis.

34. The method of claim 33, further comprising, selectively and sequentially transitioning the orientation of the front wheels and the rear wheel, in either direction, between:
a first relative position with respect to one another such that the vehicle may operate in a standard operational mode in which the vehicle moves substantially in the forward and reverse directions; and
a second relative position with respect to one another such that the vehicle may operate in a traversing mode in which the vehicle moves substantially in the right and left traversing direction;
in such a manner that orientation of the front and rear wheels is cooperatively coordinated, prior to, after, and during transitioning between the standard and traversing modes of operation.

35. The method of claim 34, further comprising, selectively moving the steering axis of at least one of the wheels between a narrow track orientation thereof and a wide track orientation thereof, while the at least one wheel remains in rolling contact with the surface.

36. The method of claim 35, further comprising, turning the one of the front wheels about its steering axis to an orientation of the one of the wheels whereat the one of the wheels will roll across the surface as the one of the wheels is moved between the narrow track and wide track orientations thereof.

37. The method of claim 36, further comprising, after a transition between narrow and wide track orientation:
turning the one of the front wheels to an orientation consistent with operation substantially in the forward and reverse directions;
or alternatively, turning the one of the front wheels to an orientation consistent with operation substantially in the right and left traversing directions.
